(19) United States
(12) Patent Application Publication
(10) Pub. No.: US 2015/0099033 A1
(43) Pub. Date: Apr. 9, 2015

(54) PROCESS FOR SHORTENING THE CONDITIONG TIME OF A COMPOSITION OF A CHEWING GUM CORE IN A CHEWING GUM PREPARATION PROCESS

(71) Applicant: SÜDZUCKER AKTIENGESELLSCHAFT MANNHEIM/OCHSENFURT, Mannheim (DE)

(72) Inventors: Tillmann Dörr, Hohen-Sulzen (DE); Bernd Haßlinger, Carlsberg (DE)

(21) Appl. No.: 14/391,212

(22) PCT Filed: Mar. 7, 2013
(86) PCT No.: PCT/EP2013/054597

§ 371 Date: Oct. 8, 2014

Related U.S. Application Data
(60) Provisional application No. 61/735,420, filed on Dec. 10, 2012.

(30) Foreign Application Priority Data
Apr. 10, 2012 (EP) 12002545.7

(51) Int. Cl. A23G 4/04; A23G 4/02

(52) U.S. Cl. CPC A23G 4/046; A23G 4/025
USPC 426/5; 426/3

(57) ABSTRACT

A process for shortening the conditioning time of a composition of a chewing gum core in a chewing gum preparation process, wherein hydrogenated or non-hydrogenated palatinose is mixed with a chewing gum base composition and to the use of hydrogenated or non-hydrogenated palatinose in a composition of a chewing gum core for shortening the conditioning time.

This application is a 371 U.S. National Phase of International Application PCT/EP2013/054597, filed on Mar. 7, 2013, which claims priority to EP 12002545.7, filed on Apr. 10, 2012, and claims the benefit of U.S. Provisional Application No. 61/735,420, filed on Dec. 10, 2012. The entire disclosures of each of the above applications are incorporated herein by reference.

The present invention relates to a process for shortening the conditioning time of a composition of a chewing gum core in a chewing gum preparation process, wherein hydrogenated or non-hydrogenated isomaltulose (isomaltulose is sold under the trademark PALATINOSE) is mixed with a chewing gum base composition and to the use of hydrogenated or non-hydrogenated isomaltulose in a composition of a chewing gum core for shortening the conditioning time.

Chewing gums containing hydrogenated isomaltulose are known. EP 0 328 849 A2 and WO95/08926 A1 disclose chewing gum compositions with hydrogenated isomaltulose as bulking agent. U.S. Pat. No. 5,958,472 A discloses the use of granulated hydrogenated isomaltulose to obtain crunchy chewing gum products.

However, for the production of sugar free chewing gums in the majority of cases maltitol or sorbitol is used instead of hydrogenated isomaltulose.

When producing a composition of a chewing gum core the composition, especially a composition comprising sorbitol, has to rest for a period, during which a kind of hardening takes place, before further processing can be done. Also formed chewing gum cores comprising sorbitol have to rest before they can be coated. The total resting time, also called conditioning time, in the production of sorbitol containing chewing gum cores is typically 12 to 24 hours.

The technical problem underlying the present invention is to provide methods and means to shortening the conditioning time of a composition of a chewing gum core and/or of formed chewing gum cores in a chewing gum preparation process.

A further technical problem underlying the present invention is to provide further applications for hydrogenated isomaltulose, especially in the production of chewing gums.

The present invention solves the underlying technical problem by the provision of a process for shortening the conditioning time of a composition of a chewing gum core in a chewing gum preparation process, comprising the following steps: a) providing hydrogenated or non-hydrogenated isomaltulose, b) providing a chewing gum base composition, c) mixing the hydrogenated or non-hydrogenated palati-nose provided in step a) with the chewing gum base composition provided in step b) to obtain a hydrogenated or non-hydrogenated isomaltulose-containing composition of a chewing gum core, d) subjecting the hydrogenated or non-hydrogenated isomaltulose-containing composition of a chewing gum core to a first shortened conditioning step and e) forming the obtained hydrogenated or non-hydrogenated isomaltulose-containing composition of a chewing gum core into a chewing gum core.

Preferably the conditioning time of step d) is reduced in comparison to the conditioning time of an amount equivalent maltitol-containing or sorbitol-containing composition of a chewing gum core.

Preferably the process is for intentionally shortening the conditioning time of the composition of a chewing gum core in a chewing gum preparation process.

In a preferred embodiment the process comprises the additional steps: f) subjecting the chewing gum core to a second shortened conditioning step, and g) coating the obtained chewing gum core.

Preferably the total conditioning time of steps d) and f) is reduced in comparison to the conditioning time of an amount equivalent maltitol-containing or sorbitol-containing composition of a chewing gum core.

The present invention solves the underlying technical problem also by the provision of a process for shortening the conditioning time of a composition of a chewing gum core and/or of a chewing gum core in a chewing gum preparation process, comprising the following steps: a) providing hydrogenated or non-hydrogenated isomaltulose, b) providing a chewing gum base composition, c) mixing the hydrogenated or non-hydrogenated isomaltulose provided in step a) with the chewing gum base composition provided in step b) to obtain a hydrogenated or non-hydrogenated isomaltulose-containing composition of a chewing gum core, d) subjecting the hydrogenated or non-hydrogenated isomaltulose-containing composition of a chewing gum core to a first conditioning step, e) forming the obtained hydrogenated or non-hydrogenated isomaltulose-containing composition of a chewing gum core into a chewing gum core, f) subjecting the chewing gum core to a second conditioning step, and g) coating the obtained chewing gum core, wherein the total conditioning time of steps d) and f) is reduced. Preferably the total conditioning time of steps d) and f) is reduced in comparison to the conditioning time of an amount equivalent maltitol-containing or sorbitol-containing composition of a chewing gum core. Preferably the process is for intentionally shortening the conditioning time of the composition of a chewing gum core in a chewing gum preparation process.

Surprisingly, it could be shown that a chewing gum base composition which is mixed with hydrogenated or non-hydrogenated isomaltulose needs a short or even no conditioning or resting time between the mixing step and a further processing step, for example a forming step, and/or between a forming step and a further processing step, e.g. a coating step. Surprisingly, the resting time needed when mixing a chewing gum base composition with hydrogenated or non-hydrogenated isomaltulose is shorter than the resting time needed in the state of the art. Accordingly the chewing gum base composition can be subjected to a shortened conditioning step when it is mixed with hydrogenated or non-hydrogenated isomaltulose. In a preferred embodiment the shortened condition time can be reduced to less than 5 hours, and even to zero or nearly zero. The reduced resting time results in a production process having increased output, whereby the conditioning time can be chosen in a flexible manner.

Furthermore the methods according to the present invention allow a continuous production of chewing gum cores and preferably coated chewing gum cores while the state of the art needs a time consuming batchwise production.

In a preferred embodiment of the present invention, the conditioning time is shortened in comparison to the conditioning time necessary for an amount equivalent maltitol-containing or sorbitol-containing composition of a chewing gum core. In a preferred embodiment of the present invention, the conditioning time is shortened in comparison to the conditioning time necessary for an amount equivalent maltitol-containing composition of a chewing gum core. In a preferred embodiment of the present invention, the conditioning time is shortened in comparison to the conditioning time necessary for an amount equivalent sorbitol-containing composition of a chewing gum core.

In the context of the present invention, the conditioning step or resting step, especially according to step d) and/or step f) of the present invention is the time which is needed for the composition of a chewing gum core, especially formed chewing gum core, for example the composition of a chewing gum core obtained in step c) and/or of a formed chewing gum core obtained in step e), to condition or to rest before it can be processed further, for example before it can be formed or coated.

In a preferred embodiment of the present invention, a shortening or reduction of the time needed for step d) of at least 10, 20, 30, 40, 50, 60, 70, 80, 90, 95%, preferably compared to a maltitol-containing or sorbitol-containing composition of a chewing gum core is preferred. A typical shortening time for a sorbitol-containing composition of a chewing gum core of about 1 day to about 4 days can be reduced for example by use of a hydrogenated or non-hydrogenated isomaltulose-containing composition of a chewing gum core to less than around 5 hours.

In a preferred embodiment of the present invention, a shortening or reduction of the time needed for step f) of at least 10, 20, 30, 40, 50, 60, 70, 80, 90, 95%, preferably compared to a maltitol-containing or sorbitol-containing composition of a chewing gum core is preferred. A typical shortening time for a sorbitol-containing composition of a chewing gum core of about 1 day to about 4 days can be reduced for example by use of a hydrogenated or non-hydrogenated isomaltulose-containing composition of a chewing gum core to less than around 5 hours.

In an even more preferred embodiment of the present invention, a total shortening or reduction of the time needed for steps d) and f) together of at least 10, 20, 30, 40, 50, 60, 70, 80, 90, 95%, preferably compared to a maltitol-containing or sorbitol-containing composition of a chewing gum core is preferred. A typical shortening time for a sorbitol-containing composition of a chewing gum core of about 1 day to about 4 days can be reduced for example by use of a hydrogenated or non-hydrogenated isomaltulose-containing composition of a chewing gum core to less than around 5 hours.

In the context of the present invention, an “amount equivalent maltitol-containing composition of a chewing gum core” is a composition of a chewing gum core which contains the same ingredients in the same amount as the composition of a chewing gum core obtained in step c) beside that the hydrogenated or non-hydrogenated isomaltulose is exchanged by the same amount of maltitol, calculated in weight. In the context of the present invention, an “amount equivalent sorbitol-containing composition of a chewing gum core” is a composition of a chewing gum core which contains the same ingredients in the same amount as the composition of a chewing gum core obtained in step c) beside that the hydrogenated or non-hydrogenated isomaltulose is exchanged by the same amount of sorbitol, calculated in weight.

In a preferred embodiment of the present invention the hydrogenated or non-hydrogenated isomaltulose-containing composition of a chewing gum core is stored in the first shortened conditioning step d) for at most 5 hours. In a preferred embodiment of the present invention the hydrogenated or non-hydrogenated isomaltulose-containing composition of a chewing gum core is stored in the first shortened conditioning step d) for at most 3 hours. In a preferred embodiment of the present invention the hydrogenated or non-hydrogenated isomaltulose-containing composition of a chewing gum core is stored in the first shortened conditioning step d) for at most 2 hours. In a preferred embodiment of the present invention the hydrogenated or non-hydrogenated isomaltulose-containing composition of a chewing gum core is stored in the first shortened conditioning step d) for at most 1 hour.

In a preferred embodiment of the present invention, the obtained hydrogenated or non-hydrogenated isomaltulose-containing composition of a chewing gum core is subjected to a shortened conditioning step d) for 0 minutes to 600 minutes. In a preferred embodiment of the present invention, the obtained hydrogenated or non-hydrogenated isomaltulose-containing composition of a chewing gum core is subjected to a shortened conditioning step d) for 0 minutes to 360 minutes. In a preferred embodiment of the present invention, the obtained hydrogenated or non-hydrogenated isomaltulose-containing composition of a chewing gum core is subjected to a shortened conditioning step d) for at most 300 minutes. In a preferred embodiment of the present invention, the obtained hydrogenated or non-hydrogenated isomaltulose-containing composition of a chewing gum core is subjected to a shortened conditioning step e) for at most 240 minutes. In a preferred embodiment of the present invention, the obtained hydrogenated or non-hydrogenated isomaltulose-containing composition of a chewing gum core is subjected to a shortened conditioning step d) for at most 200 minutes. In a preferred embodiment of the present invention, the obtained hydrogenated or non-hydrogenated isomaltulose-containing composition of a chewing gum core is subjected to a shortened conditioning step d) for at most 120 minutes. In a preferred embodiment of the present invention, the obtained hydrogenated or non-hydrogenated isomaltulose-containing composition of a chewing gum core is subjected to a shortened conditioning step d) for at most 60 minutes. In a preferred embodiment of the present invention, the obtained hydrogenated or non-hydrogenated isomaltulose-containing composition of a chewing gum core is subjected to a shortened conditioning step d) for at most 40 minutes. In a preferred embodiment of the present invention, the obtained hydrogenated or non-hydrogenated isomaltulose-containing composition of a chewing gum core is subjected to a shortened conditioning step d) for at most 30 minutes. In a preferred embodiment of the present invention, the obtained hydrogenated or non-hydrogenated isomaltulose-containing composition of a chewing gum core is subjected to a shortened conditioning step d) for at most 15 minutes. In a preferred embodiment of the present invention, the obtained hydrogenated or non-hydrogenated isomaltulose-containing composition of a chewing gum core is subjected to a shortened conditioning step d) for at most 10 minutes. In a preferred embodiment of the present invention, the obtained hydrogenated or non-hydrogenated isomaltulose-containing composition of a chewing gum core is subjected to a shortened conditioning step d) for at most 1 minute. In a preferred embodiment of the present invention, the obtained hydrogenated or non-hydrogenated isomaltulose-containing composition of a chewing gum core is subjected to essentially no shortened conditioning step d), i.e. there is essentially no conditioning step between the mixing step c) and the forming step e). In a preferred embodiment of the present invention, the obtained hydrogenated or non-hydrogenated isomaltulose-containing composition of a chewing gum core is subjected to a shortened conditioning step d) for at most 0 minutes, i.e. there is no conditioning step between the mixing step c) and the forming step e).

In a preferred embodiment of the present invention the chewing gum core is stored in the second shortened conditioning step f) for at most 5 hours. In a preferred embodiment of the present invention the chewing gum core is stored in the second shortened conditioning step f) for at most 3 hours. In a preferred embodiment of the present invention the chewing gum core is stored in the second shortened conditioning step f) for at most 2 hours. In a preferred embodiment of the present invention the chewing gum core is stored in the second shortened conditioning step f) for at most 1 hour.

In a preferred embodiment of the present invention, the obtained chewing gum core is subjected to a shortened conditioning step f) for 0 minutes to 600 minutes. In a preferred embodiment of the present invention, the obtained chewing gum core is subjected to a shortened conditioning step f) for 0 minutes to 360 minutes. In a preferred embodiment of the present invention, the obtained chewing gum core is subjected to a shortened conditioning step f) for at most 300 minutes. In a preferred embodiment of the present invention, the obtained chewing gum core is subjected to a shortened conditioning step f) for at most 240 minutes. In a preferred embodiment of the present invention, the obtained chewing gum core is subjected to a shortened conditioning step f) for at most 200 minutes. In a preferred embodiment of the present invention, the obtained chewing gum core is subjected to a shortened conditioning step f) for at most 120 minutes. In a preferred embodiment of the present invention, the obtained chewing gum core is subjected to a shortened conditioning step f) for at most 60 minutes. In a preferred embodiment of the present invention, the obtained chewing gum core is subjected to a shortened conditioning step f) for at most 40 minutes. In a preferred embodiment of the present invention, the obtained chewing gum core is subjected to a shortened conditioning step f) for at most 30 minutes. In a preferred embodiment of the present invention, the obtained chewing gum core is subjected to a shortened conditioning step f) for at most 15 minutes. In a preferred embodiment of the present invention, the obtained chewing gum core is subjected to a shortened conditioning step f) for at most 10 minutes. In a preferred embodiment of the present invention, the obtained chewing gum core is subjected to a shortened conditioning step f) for at most 1 minute. In a preferred embodiment of the present invention, the obtained h chewing gum core is subjected to essentially no shortened conditioning step f), i.e. there is essentially no conditioning step between the forming step e) and the coating step g). In a preferred embodiment of the present invention, the obtained h chewing gum core is subjected to a shortened conditioning step f) for at most 0 minutes, i.e. there is no conditioning step between the forming step e) and the coating step g).

In a preferred embodiment of the present invention the total time of the conditioning steps d) and f) is at most 10 hours. Total time means the time of the first conditioning step d) and the time of the second conditioning step f) added together. This means that the first conditioning step d) can be shorter than the second conditioning step f), longer second conditioning step f) or equal long as second conditioning step f), as long as both conditioning times together are in total not longer than outlined here.

In a preferred embodiment of the present invention the total time of the conditioning steps d) and f) is at most 8 hours. In a preferred embodiment of the present invention the total time of the conditioning steps d) and f) is at most 6 hours. In a preferred embodiment of the present invention the total time of the conditioning steps d) and f) is at most 5 hours. In a preferred embodiment of the present invention the total time of the conditioning steps d) and f) is at most 4 hours. In a preferred embodiment of the present invention the total time of the conditioning steps d) and f) is at most 3 hours. In a preferred embodiment of the present invention the total time of the conditioning steps d) and f) is at most 2 hours. In a preferred embodiment of the present invention the total time of the conditioning steps d) and f) is at most 1 hour.

In a preferred embodiment of the present invention, the obtained hydrogenated or non-hydrogenated isomaltulose-containing composition of a chewing gum core and the chewing gum core are subjected to a shortened conditioning total time of steps d) and f) for 0 minutes to 600 minutes. In a preferred embodiment of the present invention, the obtained hydrogenated or non-hydrogenated isomaltulose-containing composition of a chewing gum core and the chewing gum core are subjected to a shortened conditioning total time of steps d) and f) for 0 minutes to 360 minutes. In a preferred embodiment of the present invention, the obtained hydrogenated or non-hydrogenated isomaltulose-containing composition of a chewing gum core and the chewing gum core are subjected to a shortened conditioning total time of steps d) and f) for at most 300 minutes. In a preferred embodiment of the present invention, the obtained hydrogenated or non-hydrogenated isomaltulose-containing composition of a chewing gum core and the chewing gum core are subjected to a shortened conditioning total time of steps d) and f) for at most 240 minutes. In a preferred embodiment of the present invention, the obtained hydrogenated or non-hydrogenated isomaltulose-containing composition of a chewing gum core and the chewing gum core are subjected to a shortened conditioning total time of steps d) and f) for at most 200 minutes. In a preferred embodiment of the present invention, the obtained hydrogenated or non-hydrogenated isomaltulose-containing composition of a chewing gum core and the chewing gum core are subjected to a shortened conditioning total time of steps d) and f) for at most 120 minutes. In a preferred embodiment of the present invention, the obtained hydrogenated or non-hydrogenated isomaltulose-containing composition of a chewing gum core and the chewing gum core are subjected to a shortened conditioning total time of steps d) and f) for at most 60 minutes. In a preferred embodiment of the present invention, the obtained hydrogenated or non-hydrogenated isomaltulose-containing composition of a chewing gum core and the chewing gum core are subjected to a shortened conditioning total time of steps d) and f) for at most 40 minutes. In a preferred embodiment of the present invention, the obtained hydrogenated or non-hydrogenated isomaltulose-containing composition of a chewing gum core and the chewing gum core are subjected to a shortened conditioning total time of steps d) and f) for at most 30 minutes. In a preferred embodiment of the present invention, the obtained hydrogenated or non-hydrogenated isomaltulose-containing composition of a chewing gum core and the chewing gum core are subjected to a shortened conditioning total time of steps d) and f) for at most 15 minutes. In a preferred embodiment of the present invention, the obtained hydrogenated or non-hydrogenated isomaltulose-containing composition of a chewing gum core and the chewing gum core are subjected to a shortened conditioning total time of steps d) and f) for at most 10 minutes. In a preferred embodiment of the present invention, the obtained hydrogenated or non-hydrogenated isomaltulose-containing composition of a chewing gum core and the chewing gum core are subjected to a shortened conditioning total time of steps d) and f) for at most 2 minutes. In a preferred embodiment of the present invention, the obtained hydrogenated or non-hydrogenated isomaltulose-containing composition of a chewing gum core and the chewing gum core are subjected to a shortened conditioning total time of steps d) and f) for at most 1 minute. In a preferred embodiment of the present invention, the obtained hydrogenated or non-hydrogenated isomaltulose-containing composition of a chewing gum core and the chewing gum core are subjected to essentially no shortened conditioning total time of steps d) and f), i.e. there is essentially no conditioning step between the mixing step c) and the forming step e) and there is essentially no conditioning step between the forming step e) and the coating step g). In a preferred embodiment of the present invention, the obtained hydrogenated or non-hydrogenated isomaltulose-containing composition of a chewing gum core and the chewing gum core are subjected to a shortened conditioning total time of steps d) and f) for at most 0 minutes, i.e. there is no conditioning step between the mixing step c) and the forming step e) and there is no conditioning step between the forming step e) and the coating step g).

In a preferred embodiment of the present invention, the process according to the present invention is for intentionally shortening the conditioning time of a composition of a chewing gum core in a chewing gum preparation process. The term “intentionally” means that the purpose of reducing the stickiness is purposefully desired, recognized and achieved and is not solely reached by chance and/or unrecognized.

A person skilled in the art knows suitable machineries for producing chewing gums.

In a preferred embodiment of the present invention, the chewing gum base composition is mixed with hydrogenated or non-hydrogenated isomaltulose in a kneader. In a preferred embodiment of the present invention, the kneader is a Z-kneader or a double-Z-kneader.

In a preferred embodiment of the present invention, the hydrogenated or non-hydrogenated isomaltulose-containing composition of a chewing gum core is formed in forming step e) as a chewing gum core having a specific form, for example the form of a chewing gum cushion. In a preferred embodiment of the present invention, the formed chewing gum core is formed in step e) in an extruder.

In a preferred embodiment of the present invention, the further processing step g) is a coating step to obtain a coated chewing gum core. Preferably the coating is a sugar-coating or a pan-coating. In a preferred embodiment of the present invention, the chewing gum core is coated in a pan-coater or coating drum.

If not outlined else, %-values given the in present description mean weight-%.

In a preferred embodiment of the present invention at least 10 weight-% to at most 80 weight-% of the hydrogenated or non-hydrogenated isomaltulose is mixed in step c) with at least 20 weight-% to at most 90 weight-% of the chewing gum base composition (referring to the total weight amount of the obtained hydrogenated or non-hydrogenated isomaltulose-containing composition of a chewing gum core). In a preferred embodiment of the present invention at least 15 weight-% to at most 75 weight-% of the hydrogenated or non-hydrogenated isomaltulose is mixed in step c) with at least 25 weight-% to at most 85 weight-% of the chewing gum base composition (referring to the total weight amount of the obtained hydrogenated or non-hydrogenated isomaltulose-containing composition of a chewing gum core).

In a preferred embodiment of the present invention at least 10 weight-% to at most 60 weight-% of the hydrogenated isomaltulose is mixed in step c) with at least 40 weight-% to at most 90 weight-% of the chewing gum base composition (referring to the total weight amount of the obtained hydrogenated isomaltulose-containing composition of a chewing gum core). In preferred embodiment of the present invention at least 25 weight-% to at most 45 weight-% of the hydrogenated isomaltulose is mixed in step c) with at least 55 weight-% to at most 75 weight-% of the chewing gum base composition (referring to the total weight amount of the obtained hydrogenated isomaltulose-containing composition of a chewing gum core). In a most preferred embodiment of the present invention around 30 weight-% to around 40 weight-% of the hydrogenated isomaltulose is mixed in step c) with at around 70 weight-% to around 60 weight-% of the chewing gum base composition (referring to the total weight amount of the obtained hydrogenated isomaltulose-containing composition of a chewing gum core).

In a preferred embodiment of the present invention at least 10 weight-% to at most 90 weight-% of the non-hydrogenated isomaltulose is mixed in step c) with at least 20 weight-% to at most 90 weight-% of the chewing gum base composition (referring to the total weight amount of the obtained non-hydrogenated isomaltulose-containing composition of a chewing gum core). In a preferred embodiment of the present invention at least 30 weight-% to at most 80 weight-% of the non-hydrogenated isomaltulose is mixed in step c) with at least 20 weight-% to at most 70 weight-% of the chewing gum base composition (referring to the total weight amount of the obtained non-hydrogenated isomaltulose-containing composition of a chewing gum core). In a preferred embodiment of the present invention at least 55 weight-% to at most 75 weight-% of the non-hydrogenated isomaltulose is mixed in step c) with at least 25 weight-% to at most 45 weight-% of the chewing gum base composition (referring to the total weight amount of the obtained non-hydrogenated isomaltulose-containing composition of a chewing gum core). In a most preferred embodiment of the present invention around 60 weight-% to around 75 weight-% of the non-hydrogenated isomaltulose is mixed in step c) with at around 25 weight-% to around 40 weight-% of the chewing gum base composition (referring to the total weight amount of the obtained non-hydrogenated isomaltulose-containing composition of a chewing gum core).

In a preferred embodiment of the present invention, hydrogenated isomaltulose is provided in step a).

In the context of the present invention, the term “hydrogenated isomaltulose” preferably encompasses an isomalt component.

In the context of the present invention, the term “isomalt component” preferably encompasses isomalt, isomalt ST, isomalt GS, an isomalt variant or component thereof. Isomalt is sold under the trademark PALATINIT.

In a preferred embodiment of the present invention, the hydrogenated isomaltulose is selected from the group consisting of 1,1-GPS (1-O-α-D-glucopyranosyl-D-sorbitol), 1,1-GPM (1-O-α-D-glucopyranosyl-D-mannitol), 1,6-GPS (6-O-α-D-glucopyranosyl-D-sorbitol), isomalt, isomalt ST and isomalt GS.

In the context of the present invention, isomalt is a mixture of 1,6-GPS and 1,1-GPM, while isomalt ST is a mixture of 53 to 47% 1,6-GPS and 47 to 53% 1,1-GPM. Isomalt GS is a mixture of 71 to 79% 1,6-GPS and 29 to 21% 1,1-GPM, preferably 75% 1,6-GPS to 25% 1,1-GPM (values given in weight-% on dry matter).

In a further preferred embodiment, it is foreseen to use isomalt variants. In the context of the present invention, isomalt variants are for instance mixtures of 10 to 50% 1,6-GPS, 2 to 20% 1,1-GPS and 30 to 70% 1,1-GPM or mixtures of 5 to 10% 1,6-GPS, 30 to 40% 1,1-GPS and 45 to 60% 1,1-GPM. Isomalt variants may also be in form of 1,6-GPS or 1,1-GPM enriched mixtures. 1,6-GPS enriched mixtures have an 1,6-GPS amount of 58 to 99% and an 1,1-GPM amount of 42 to 1%. 1,1-GPM enriched mixtures have an 1,6-GPS amount of 1 to 42% and an 1,1-GPM amount of 58 to 99% (values given in weight-% on dry matter).

In a further preferred embodiment of the present invention, the isomalt component used is a milled and agglomerated isomalt, in particular a milled and agglomerated isomalt, wherein the milled isomalt particles have a diameter of less than 100 μm, preferably less than 50 μm. Preferably, such a milled and agglomerated isomalt is isomalt DC.

Particle size as described herein is measured by scanning electron microscopy (SEM) or other optical or scanning techniques, for example using a coulter counter.

In a preferred embodiment of the present invention at least 10 weight-% to at most 75 weight-% of the hydrogenated isomaltulose is mixed in step c) with at least 20 weight-% to at most 90 weight-% of the chewing gum base composition (referring to the total weight amount of the obtained hydrogenated isomaltulose-containing composition of a chewing gum core). In a more preferred embodiment of the present invention at least 10 weight-% to at most 60 weight-% of the hydrogenated isomaltulose is mixed in step c) with at least 20 weight-% to at most 90 weight-% of the chewing gum base composition.

In a preferred embodiment of the present invention at least 10 weight-% of the hydrogenated isomaltulose (referring to the total weight amount of the obtained hydrogenated isomaltulose-containing composition of a chewing gum core) is mixed in step c) with the chewing gum base composition. Accordingly the chewing gum base composition obtained in step c) contains preferably at least 10 weight-% of the hydrogenated isomaltulose. In a preferred embodiment of the present invention at least 15 weight-% of the hydrogenated isomaltulose (referring to the total weight amount of the obtained hydrogenated isomaltulose-containing composition of a chewing gum core) is mixed in step c) with the chewing gum base composition. In a preferred embodiment of the present invention at least 20 weight-% of the hydrogenated isomaltulose (referring to the total weight amount of the obtained hydrogenated isomaltulose-containing composition of a chewing gum core) is mixed in step c) with the chewing gum base composition. In a preferred embodiment of the present invention at most 60 weight-% of the hydrogenated isomaltulose (referring to the total weight amount of the obtained hydrogenated isomaltulose-containing composition of a chewing gum core) is mixed in step c) with the chewing gum base composition. In a preferred embodiment of the present invention at most 50 weight-% of the hydrogenated isomaltulose (referring to the total weight amount of the obtained hydrogenated isomaltulose-containing composition of a chewing gum core) is mixed in step c) with the chewing gum base composition. In a preferred embodiment of the present invention at most 40 weight-% of the hydrogenated isomaltulose (referring to the total weight amount of the obtained hydrogenated isomaltulose-containing composition of a chewing gum core) is mixed in step c) with the chewing gum base composition. In a preferred embodiment of the present invention around 20 weight-% to around 40 weight-% of the hydrogenated isomaltulose (referring to the total weight amount of the obtained hydrogenated isomaltulose-containing composition of a chewing gum core) is mixed in step c) with the chewing gum base composition. In a preferred embodiment of the present invention around 30 weight-% of the hydrogenated isomaltulose (referring to the total weight amount of the obtained hydrogenated isomaltulose-containing composition of a chewing gum core) is mixed in step c) with the chewing gum base composition. Accordingly the chewing gum base composition obtained in step c) can contain at least 10 weight-%, at least 15 weight-% or at least 20 weight-% and/or at most 60 weight-%, at most 50 weight-% or at most 40 weight-% of the hydrogenated isomaltulose. Accordingly the chewing gum base composition obtained in step c) can contain also around 20 to around 40 weight-% of the hydrogenated isomaltulose, most preferably around 30 weight-% of the hydrogenated isomaltulose.

In an alternative embodiment of the present invention, non-hydrogenated isomaltulose is provided in step a).

Non-hydrogenated isomaltulose, also termed isomaltulose, is a disaccharide made from sucrose by the enzymatic rearrangement of the alpha-1,2-linkage between glucose and fructose to an alpha-1,6-linkage.

In a preferred embodiment of the present invention the non-hydrogenated isomaltulose is provided in step a) in an amount of at least 10% to at most 75% by weight of the total weight of the obtained non-hydrogenated isomaltulose-containing composition of a chewing gum core.

In a preferred embodiment of the present invention at least 20 weight-% to at most 80 weight-% of the non-hydrogenated isomaltulose is mixed in step c) with at least 80 weight-% to at most 20 weight-% of the chewing gum base composition (referring to the total weight amount of the obtained non-hydrogenated isomaltulose-containing composition of a chewing gum core). In a more preferred embodiment of the present invention at least 30 weight-% to at most 75 weight-% of the non-hydrogenated isomaltulose is mixed in step c) with at least 25 weight-% to at most 70 weight-% of the chewing gum base composition. In a preferred embodiment of the present invention at least 40 weight-% of the non-hydrogenated isomaltulose (referring to the total weight amount of the obtained non-hydrogenated isomaltulose-containing composition of a chewing gum core) is mixed in step c) with the chewing gum base composition. Accordingly the chewing gum base composition obtained in step c) contains preferably at least 40 weight-% of the hydrogenated isomaltulose. In a preferred embodiment of the present invention at least 50 weight-% of the non-hydrogenated isomaltulose (referring to the total weight amount of the obtained non-hydrogenated isomaltulose-containing composition of a chewing gum core) is mixed in step c) with the chewing gum base composition. In a preferred embodiment of the present invention at least 60 weight-% of the non-hydrogenated isomaltulose (referring to the total weight amount of the obtained non-hydrogenated isomaltulose-containing composition of a chewing gum core) is mixed in step c) with the chewing gum base composition. In a preferred embodiment of the present invention at most 80 weight-% of the non-hydrogenated isomaltulose (referring to the total weight amount of the obtained non-hydrogenated isomaltulose-containing composition of a chewing gum core) is mixed in step c) with the chewing gum base composition. In a preferred embodiment of the present invention at most 75 weight-% of the non-hydrogenated isomaltulose (referring to the total weight amount of the obtained non-hydrogenated isomaltulose-containing composition of a chewing gum core) is mixed in step c) with the chewing gum base composition. In a preferred embodiment of the present invention at most 70 weight-% of the non-hydrogenated isomaltulose (referring to the total weight amount of the obtained non-hydrogenated isomaltulose-containing composition of a chewing gum core) is mixed in step c) with the chewing gum base composition. In a preferred embodiment of the present invention around 60 weight-% to around 70 weight-% of the non-hydrogenated isomaltulose (referring to the total weight amount of the obtained non-hydrogenated isomaltulose-containing composition of a chewing gum core) is mixed in step c) with the chewing gum base composition. In a preferred embodiment of the present invention around 62 weight-% of the non-hydrogenated isomaltulose (referring to the total weight amount of the obtained non-hydrogenated isomaltulose-containing composition of a chewing gum core) is mixed in step c) with the chewing gum base composition. Accordingly the chewing gum base composition obtained in step c) can contain at least 10 weight-%, at least 50 weight-% or at least 60 weight-% and/or at most 90 weight-%, at most 80 weight-% or at most 75 weight-% of the non-hydrogenated isomaltulose. Accordingly the chewing gum base composition obtained in step c) can contain also around 60 to around 75 weight-% of the non-hydrogenated isomaltulose.

In a preferred embodiment of the present invention, a mixture of hydrogenated and non-hydrogenated isomaltulose is provided in step a).

In a preferred embodiment of the present invention, the chewing gum base composition provided in step b) comprises at least one chewing gum base component. The chewing gum base component is also known as “gum base”.

In a preferred embodiment of the present invention, the chewing gum base composition provided in step b) comprises at least one water insoluble chewing gum base component.

In a preferred embodiment of the present invention, the chewing gum base composition provided in step b) comprises the at least one chewing gum base component in an amount of 15% by weight to 50% by weight of the total weight of the obtained non-hydrogenated isomaltulose-containing composition of a chewing gum core. In a preferred embodiment of the present invention, the at least one chewing gum base component is present in an amount of at least 20% by weight of the total weight of the obtained non-hydrogenated isomaltulose-containing composition of a chewing gum core. In a preferred embodiment of the present invention, the at least one chewing gum base component is present in an amount of at least 25% by weight of the total weight of the obtained non-hydrogenated isomaltulose-containing composition of a chewing gum core. In a preferred embodiment of the present invention, the at least one chewing gum base component is present in an amount of at most 45% by weight of the total weight of the obtained non-hydrogenated isomaltulose-containing composition of a chewing gum core. In a preferred embodiment of the present invention, the at least one chewing gum base component is present in an amount of at most 40% by weight of the total weight of the obtained non-hydrogenated isomaltulose-containing composition of a chewing gum core. In a preferred embodiment of the present invention, the at least one chewing gum base component is present in an amount of at least 20% by weight and at most 40% by weight of the total weight of the obtained non-hydrogenated isomaltulose-containing composition of a chewing gum core. In a preferred embodiment of the present invention, the at least one chewing gum base component is present in an amount of at least 25% by weight and at most 35% by weight of the total weight of the obtained non-hydrogenated isomaltulose-containing composition of a chewing gum core. The at least one chewing gum base component can be present for example in an amount of at least 32% by weight and at most 34% by weight of the total weight of the obtained non-hydrogenated isomaltulose-containing composition of a chewing gum core.

In the context of the present invention the term “comprising” preferably has the meaning of “containing” or “including” meaning that the composition in question at least comprises the specifically identified component without excluding the presence of further components. However, in a preferred embodiment the term comprising is also understood to have the meaning of “consisting essentially of” and in a most preferred embodiment of “consisting”. The term “consisting essentially of” excludes the presence of substantial amounts of further components except the specifically identified component of the composition. The term “consisting” excludes the presence of any further compound, no matter in which quantity in the composition identified.

In the context of the present invention the term “comprising essentially” preferably has the meaning that the specifically identified component is the component with the highest proportion in the composition in question compared to the components present in the composition in question. However, in a preferred embodiment the term “comprising essentially” means that the composition in question comprises at least 50% by weight, even more preferably at least 51% by weight of the specifically identified component.

In the context of the present invention the term “at least one” preferably has the meaning that on component or more than one components, for example two, three or more components are present.

In a preferred embodiment of the present invention, the chewing gum base composition provided in step b) comprises at least one chewing gum base component selected from the group consisting of at least one sweetener component, at least one high intensity sweetener component, at least one flavouring component, at least one colouring component and at least one rolling component.

In a preferred embodiment of the present invention, the chewing gum base composition provided in step b) comprises at least one chewing gum base component selected from the group consisting of at least one high intensity sweetener component, at least one flavouring component, at least one colouring component and at least one rolling component.

In a preferred embodiment of the present invention, the chewing gum base composition provided in step b) comprises a sugar alcohol or a sugar. In a preferred embodiment of the present invention, the chewing gum base composition provided in step b) comprises a sugar alcohol. In a preferred embodiment of the present invention, the chewing gum base composition provided in step b) comprises a sugar.

In a preferred embodiment of the present invention, the chewing gum base composition provided in step b) comprises at least one sugar alcohol in case hydrogenated isomaltulose is provided in step a).

In a preferred embodiment of the present invention, the chewing gum base composition provided in step b) comprises a sugar alcohol in case hydrogenated isomaltulose is provided in step a).

In a preferred embodiment of the present invention, the chewing gum base composition provided in step b) comprises maltitol and/or sorbitol in case hydrogenated isomaltulose is provided in step a). In a preferred embodiment of the present invention, the chewing gum base composition provided in step b) comprises maltitol and sorbitol in case hydrogenated isomaltulose is provided in step a). In a preferred embodiment of the present invention, the chewing gum base composition provided in step b) comprises maltitol in case hydrogenated isomaltulose is provided in step a). In a preferred embodiment of the present invention, the chewing gum base composition provided in step b) comprises sorbitol in case hydrogenated isomaltulose is provided in step a).

In a preferred embodiment of the present invention, the chewing gum base composition provided in step b) comprises at least one sugar in case non-hydrogenated isomaltulose is provided in step a).

In a preferred embodiment of the present invention, the chewing gum base composition provided in step b) comprises a sugar in case non-hydrogenated isomaltulose is provided in step a).

In a preferred embodiment of the present invention, the chewing gum base composition provided in step b) comprises a monosaccharide and/or a disaccharide in case non-hydrogenated isomaltulose is provided in step a). In a preferred embodiment of the present invention, the chewing gum base composition provided in step b) comprises trehalulose in case non-hydrogenated isomaltulose is provided in step a). In a preferred embodiment of the present invention, the chewing gum base composition provided in step b) comprises trehalose in case non-hydrogenated isomaltulose is provided in step a).

In a preferred embodiment of the present invention, the chewing gum base composition provided in step b) comprises no hydrogenated or non-hydrogenated isomaltulose.

In a preferred embodiment of the present invention, the chewing gum base composition provided in step b) comprises a sugar alcohol but no hydrogenated or non-hydrogenated isomaltulose. In a preferred embodiment of the present invention, the chewing gum base composition provided in step b) comprises a sugar but no hydrogenated or non-hydrogenated isomaltulose.

In a preferred embodiment of the present invention, the chewing gum base composition provided in step b) comprises no sugar alcohol selected from the group consisting of maltitol, mannitol, xylitol, sorbitol, erythritol and mixtures thereof. In a preferred embodiment of the present invention, the chewing gum base composition provided in step b) comprises no sugar alcohol selected from the group consisting of mannitol, xylitol, sorbitol, erythritol and mixtures thereof. In a preferred embodiment of the present invention, the chewing gum base composition provided in step b) comprises no sugar alcohol selected from the group consisting of maltitol, mannitol, xylitol, erythritol and mixtures thereof. In a preferred embodiment of the present invention, the chewing gum base composition provided in step b) comprises no sugar alcohol selected from the group consisting of, mannitol, xylitol, erythritol and mixtures thereof.

In a preferred embodiment of the present invention, the chewing gum base composition provided in step b) comprises no maltitol. In a preferred embodiment of the present invention, the chewing gum base composition provided in step b) comprises no mannitol. In a preferred embodiment of the present invention, the chewing gum base composition provided in step b) no xylitol. In a preferred embodiment of the present invention, the chewing gum base composition provided in step b) comprises no sorbitol. In a preferred embodiment of the present invention, the chewing gum base composition provided in step b) comprises no erythritol.

In a preferred embodiment of the present invention, the chewing gum base composition provided in step b) comprises sorbitol and maltitol. In a preferred embodiment of the present invention, the chewing gum base composition provided in step b) comprises sorbitol. In a preferred embodiment of the present invention, the chewing gum base composition provided in step b) comprises maltitol.

In a preferred embodiment of the present invention, the chewing gum base composition provided in step b) comprises sorbitol but no maltitol. In a preferred embodiment of the present invention, the chewing gum base composition provided in step b) comprises maltitol but no sorbitol.

Chewing gum cores often contain mixtures of different sugar alcohols or of different sugars. Accordingly, in a preferred embodiment of the present invention, the chewing gum base composition provided in step b) comprises a mixture of sorbitol and maltitol.

In a preferred embodiment of the present invention, the chewing gum base composition provided in step b) is sugar-free. In a further preferred embodiment, the chewing gum base composition provided in step b) is free of sucrose, free of glucose, free of lactose and/or free of fructose or free of combinations of at least two of these sugars.

In a preferred embodiment of the present invention, the chewing gum base composition provided in step b) is tooth-friendly.

In a preferred embodiment of the present invention, the chewing gum base composition provided in step b) is sugar-free, in particular free of sucrose, free of glucose, free of lactose and/or free of fructose or free of combinations of at least two of these sugars.

In a preferred embodiment of the present invention, the chewing gum base composition provided in step b) comprises at least one tooth-friendly sugar or sugar alcohol.

In a preferred embodiment of the present invention, the at least one tooth-friendly sugar in the chewing gum base composition provided in step b) is selected from the group consisting of isomaltulose, nutriose, leukrose and polydextrose. In a further preferred embodiment, the amount of non-tooth-friendly ingredients is at maximum 1 weight-% (on total weight of the confectionery product). In a preferred embodiment of the present invention, the at least one tooth-friendly sugar in the chewing gum base composition provided in step b) is selected from the group consisting of nutriose, leukrose and polydextrose. In a further preferred embodiment, the amount of non-tooth-friendly ingredients is at maximum 1 weight-% (on total weight of the confectionery product).

In a further preferred embodiment of the present invention, the at least one tooth-friendly sugar alcohol in the chewing gum base composition provided in step b) is selected from the group of xylitol, mannitol, maltitol, erythritol, lactitol or sorbitol.

In a preferred embodiment of the present invention, the chewing gum base composition provided in step b) comprises further at least one additive.

In a preferred embodiment of the present invention, the at least one additive is selected from the group consisting of sugars, preferably tooth-friendly sugars, sugar alcohols, intense sweeteners, hydrocolloid, gum base, plastifiers, lubricant, emulsifiers, protein components, milk components, dairy ingredients, fat and fat substitutes, vegetable fat, vitamins, minerals, pharmaceutically active ingredients, preservatives, aroma, flavourings, such as peppermint, menthol, fruit, strawberry flavour, colours, TiO₂, edible acids, such as citric acid, and dietary fibres.

In a preferred embodiment of the present invention, the chewing gum base composition provided in step b) is a chewing gum base composition known in the state of the art. A person skilled in the art knows suitable chewing gum base compositions.

In a preferred embodiment of the present invention, the composition of a chewing gum core obtained in step c) consists essentially of the hydrogenated or non-hydrogenated isomaltulose provided in step a) and the chewing gum base composition provided in step b). In a preferred embodiment of the present invention, the composition of a chewing gum core obtained in step c) consists of the hydrogenated or non-hydrogenated isomaltulose provided in step a) and the chewing gum base composition provided in step b).

In a preferred embodiment of the present invention, the composition of a chewing gum core obtained in step c) comprises at least 20 weight-% sorbitol and/or maltitol (referring to the total weight amount of the obtained hydrogenated or non-hydrogenated isomaltulose-containing composition of a chewing gum core). In a preferred embodiment of the present invention, the composition of a chewing gum core obtained in step c) comprises at most 50 weight-% sorbitol and/or maltitol (referring to the total weight amount of the obtained hydrogenated or non-hydrogenated isomaltulose-containing composition of a chewing gum core). In a preferred embodiment of the present invention, the composition of a chewing gum core obtained in step c) comprises at least 21 weight-% sorbitol and/or maltitol (referring to the total weight amount of the obtained hydrogenated or non-hydrogenated isomaltulose-containing composition of a chewing gum core). In a preferred embodiment of the present invention, the composition of a chewing gum core obtained in step c) comprises at most 49 weight-% sorbitol and/or maltitol (referring to the total weight amount of the obtained hydrogenated or non-hydrogenated isomaltulose-containing composition of a chewing gum core).

In a preferred embodiment of the present invention, the composition of a chewing gum core obtained in step c) comprises at least 20 weight-% and at most 50 weight-% sorbitol and/or maltitol (referring to the total weight amount of the obtained hydrogenated or non-hydrogenated isomaltulose-containing composition of a chewing gum core) and at least 10 weight-% and at most 50 weight-% hydrogenated isomaltulose (referring to the total weight amount of the obtained hydrogenated or non-hydrogenated isomaltulose-containing composition of a chewing gum core). In a preferred embodiment of the present invention, the composition of a chewing gum core obtained in step c) comprises at least 21 weight-% and at most 49 weight-% sorbitol and/or maltitol (referring to the total weight amount of the obtained hydrogenated or non-hydrogenated isomaltulose-containing composition of a chewing gum core) and at least 25 weight-% and at most 45 weight-% hydrogenated isomaltulose (referring to the total weight amount of the obtained hydrogenated or non-hydrogenated isomaltulose-containing composition of a chewing gum core). In a preferred embodiment of the present invention, the composition of a chewing gum core obtained in step c) comprises around 20 weight-% sorbitol and/or maltitol (referring to the total weight amount of the obtained hydrogenated or non-hydrogenated isomaltulose-containing composition of a chewing gum core) and around 30 weight-% weight-% hydrogenated isomaltulose (referring to the total weight amount of the obtained hydrogenated or non-hydrogenated isomaltulose-containing composition of a chewing gum core).

In a preferred embodiment of the present invention, the composition of a chewing gum core obtained in step c) comprises at least 10 weight-% and at most 30 weight-% sorbitol (referring to the total weight amount of the obtained hydrogenated or non-hydrogenated isomaltulose-containing composition of a chewing gum core), at least 10 weight-% and at most 20 weight-% maltitol (referring to the total weight amount of the obtained hydrogenated or non-hydrogenated isomaltulose-containing composition of a chewing gum core) and at least 30 weight-% and at most 45 weight-% hydrogenated isomaltulose (referring to the total weight amount of the obtained hydrogenated or non-hydrogenated isomaltulose-containing composition of a chewing gum core).

In a preferred embodiment of the present invention, the composition of a chewing gum core obtained in step c) comprises at least 40 weight-% and at most 60 weight-% of at least one sugar alcohol (referring to the total weight amount of the obtained hydrogenated or non-hydrogenated isomaltulose-containing composition of a chewing gum core).

In a preferred embodiment of the present invention, the composition of a chewing gum core obtained in step c) comprises at least 50 weight-% and at most 75 weight-% of at least one sugar (referring to the total weight amount of the obtained hydrogenated or non-hydrogenated isomaltulose-containing composition of a chewing gum core).

In a preferred embodiment of the present invention, the composition of a chewing gum core obtained in step c) comprises non-hydrogenated isomaltulose and at least 0 weight-% to at most 95 weight-% trehalulose (referring to the total weight amount of the obtained hydrogenated or non-hydrogenated isomaltulose-containing composition of a chewing gum core).

In a preferred embodiment of the present invention, the composition of a chewing gum core obtained in step c) comprises non-hydrogenated isomaltulose and at least 0 weight-% to at most 95 weight-% trehalose (referring to the total weight amount of the obtained hydrogenated or non-hydrogenated isomaltulose-containing composition of a chewing gum core).

In a particularly preferred embodiment of the present invention, the hydrogenated or non-hydrogenated isomaltulose is essentially the only sweetening agent present in the composition of a chewing gum core obtained in step c). In a particularly preferred embodiment of the present invention, the hydrogenated or non-hydrogenated isomaltulose is the only sweetening agent present in the composition of a chewing gum core obtained in step c). In a preferred embodiment of the present invention, the non-hydrogenated isomaltulose is the only sugar present in the composition of a chewing gum core obtained in step c). In a further preferred embodiment of the present invention, the hydrogenated isomaltulose is the only sugar alcohol present in the composition of a chewing gum core obtained in step c). In a further preferred embodiment, the hydrogenated or non-hydrogenated isomaltulose is the only sweetening agent providing a body to the composition of a chewing gum core obtained in step c). Thus, in this preferred embodiment, in addition to the hydrogenated or non-hydrogenated isomaltulose, an intense sweetener may also be present the composition of a chewing gum core obtained in step c).

In a further preferred embodiment of the present invention, the hydrogenated isomaltulose and sorbitol are the only sugar alcohols present in the composition of a chewing gum core obtained in step c). In a further preferred embodiment of the present invention, the hydrogenated isomaltulose and maltitol are the only sugar alcohols present in the composition of a chewing gum core obtained in step c). In a further preferred embodiment of the present invention, the hydrogenated isomaltulose, sorbitol and maltitol are the only sugar alcohols present in the composition of a chewing gum core obtained in step c).

In a preferred embodiment of the present invention, the non-hydrogenated isomaltulose is essentially the only sugar present in the composition of a chewing gum core obtained in step c). In a further preferred embodiment of the present invention, the hydrogenated isomaltulose is the essentially only sugar alcohol present in the composition of a chewing gum core obtained in step c). In a further preferred embodiment, the hydrogenated or non-hydrogenated isomaltulose is the essentially only sweetening agent providing a body to the composition of a chewing gum core obtained in step c).

In a preferred embodiment, the composition of a chewing gum core obtained in step c) comprises an intense sweetener.

In a preferred embodiment of the present invention, the intense sweetener is selected from the group of cyclamate, saccharin, aspartame, glycyrrhicine, neohesperidine-dihydrochalcone, steveoside, thaumatin, monellin, acesulfame, alitame, sucralose or a mixture thereof.

After the ingredients have been thoroughly mixed or kneaded, in step c) the composition of a chewing gum core is discharged from the mixer or kneader and is further processed, for example shaped into the desired form such as by rolling into sheets and cutting into sticks, extruding into chunks or casting into pellets. Generally, ingredients of the chewing gum core material are mixed by first melting the gum base and adding it into the running mixer. The base may also be melted in the mixer itself. Colour or emulsifiers may also be added at this time. A softener such as glycerine may also be added at this time along with syrup and a portion of bulking agent. Further portions of the bulking agent may then be added to the mixer. A flavouring agent is typically added with a final portion of the bulking agent. The entire mixing or kneading procedure typically takes from 5 to 50 minutes, but longer mixing times may sometimes be required. Those skilled in the art will recognise that many variations of the above-described procedure may be followed.

The hydrogenated or non-hydrogenated isomaltulose provided in step a) can be added to the first chewing gum processing machinery before or after adding the chewing gum base composition provided in step b). The hydrogenated or non-hydrogenated isomaltulose provided in step a) can also be added during the mixing of the components of the chewing gum base composition provided in step b). The hydrogenated or non-hydrogenated isomaltulose provided in step a) can also be added stepwise.

The present invention solves the underlying technical problem also by the use of hydrogenated or non-hydrogenated isomaltulose in a composition of a chewing gum core for shortening the conditioning time of the composition of a chewing gum core in a chewing gum preparation process.

In a preferred embodiment of the present invention, the conditioning time is shortened in comparison to the conditioning time necessary for an amount equivalent maltitol-containing or sorbitol-containing composition of a chewing gum core. In a preferred embodiment of the present invention, the conditioning time is shortened in comparison to the conditioning time necessary for an amount equivalent maltitol-containing composition of a chewing gum core.

In a preferred embodiment of the present invention, the conditioning time is shortened in comparison to the conditioning time necessary for an amount equivalent sorbitol-containing composition of a chewing gum core.

In a preferred embodiment, the hydrogenated or non-hydrogenated isomaltulose is used intentionally for shortening the conditioning time of a composition of a chewing gum core in a chewing gum preparation process.

The present invention solves the underlying technical problem also by the use of hydrogenated or non-hydrogenated isomaltulose in a composition of a chewing gum core for intentionally shortening the conditioning time of the composition of a chewing gum core in a chewing gum preparation process, wherein the conditioning time is shortened in comparison to the conditioning time of an amount equivalent maltitol-containing composition of a chewing gum core.

The present invention solves the underlying technical problem also by the use of hydrogenated or non-hydrogenated isomaltulose in a composition of a chewing gum core for intentionally shortening the total conditioning time in a preparation process of a formed and coated chewing gum core from the composition of a chewing gum core, wherein the total conditioning time is shortened in comparison to the total conditioning time in a preparation process of a formed and coated chewing gum core from an amount equivalent maltitol-containing composition of a chewing gum core.

Preferred embodiments of the use according to the present invention concerning the hydrogenated or non-hydrogenated isomaltulose, the chewing gum base composition, the composition of a chewing gum core and/or the chewing gum processing machinery are outlined in the description of the process according to the present invention.

The present invention solves the underlying technical problem also by the provision of a hydrogenated or non-hydrogenated isomaltulose-containing composition of a chewing gum core, preferably produced in the process according to the present invention, wherein the composition of a chewing gum core has shortened conditioning time. Preferred embodiments of the hydrogenated or non-hydrogenated isomaltulose-containing composition of a chewing gum core according to the present invention concerning the hydrogenated or non-hydrogenated isomaltulose, the chewing gum base composition, the composition of a chewing gum core and/or the chewing gum processing machinery are outlined in the description of the process according to the present invention.

The present invention solves the underlying technical problem by the provision of a chewing gum core made from the composition of a chewing gum core obtained in step e). In a preferred embodiment the chewing gum core is provided as a sheet.

In a preferred embodiment of the present invention, the chewing gum core is a filled or non-filled chewing gum core.

The present invention solves the underlying technical problem by the provision of a chewing gum product comprising the composition of a chewing gum core obtained after step e), more preferably after step g). The chewing gum products may be coated or non-coated chewing gum products. Thus, the present invention foresees in one embodiment to provide non-coated chewing gum products such as chewing gum sticks. In another preferred embodiment the present invention foresees to coat the chewing gum product prepared according to the present invention with at least one layer of coating material so as to produce a coated chewing gum product and wherein said at least one layer is enveloping the rolling compound present on the surface of the chewing gum core material.

Further preferred embodiments of the present invention are the subject matter of the subclaims.

### EXAMPLE 1

### Chewing Gum Core Production Using Hydrogenated Isomaltulose

| a) Recipes of the chewing gum core: | [kg] | [%] |
|---|---|---|
| GUM BASE DALIA (Cafosa) | 48 | 32 |
| Hydrogenated isomaltulose (ISOMALT ST/PF) | 45 | 30 |
| SORBITOL (Roquette) | 36 | 24 |
| LYCASIN 80/55 (Roquette) | 15.9 | 10.6 |
| MENTHOL 163592 (Symrise) | 2.1 | 1.4 |
| PEPPERMINTOIL OPTAMINT 219843 (Symrise) | 2.7 | 1.8 |
| ASPARTAME | 0.15 | 0.1 |
| ACESULFAME K | 0.15 | 0.1 |
| Total | 150 | 100 |

300 kg (2 batches for the kneader) of this recipe were made in a 250 litre kneader from Gabler GmbH & Co. KG.

b) Kneading:

the kneader was heated to 50° C., the Lycasin syrup and the gum base (10 min kneading) was filled in and warmed up, and the sorbitol and the intense sweeteners were added, the mixture was kneaded for 10 min, the Isomalt ST/PF and the flavours were added and the batch was kneaded for again 20 min.

c) Conditioning Step:

The obtained mixture was rested for 30 minutes.

d) Further Processing:

After a rest period of 30 min the mass was ready to start on a extruder before the rolling and scoring machine. To start the extrusion process the mass was cutted into pieces (2-4 kg) and feed into the extruder. The temperature of the mass was 35-40° C. The discharge from the extruder was smooth on the edges so that the mass could be rolled and scored exactly. The cutted borders of the chewing gum sheets were refeeded automatically to the extruder, positioned at the beginning of the production line. The used talcum was also refeeded to the talcum hoard tank. The line has 5 rollers to bring the chewing gum mass to the right thickness and breadth. After the 5 prerollers, knife-rollers (lengthwise/across) were used. After cutting the sheets, the length and the thickness were measured and a metal detector was installed.

e) Result:

The stability of the chewing gum cores is very good and suited for each size of coating machines.

### EXAMPLE 2

### Chewing Gum Core Production Using Non-Hydrogenated Isomaltulose

a) Recipes of the chewing gum core:

| | [kg] | [%] |
|---|---|---|
| GUM BASE DALIA (Cafosa) | 51 | 34 |
| ISOMALTULOSE PAP/PA | 93.375 | 62.25 |
| GLYCEROL | 0.975 | 0.65 |
| MENTHOL 163592 (Symrise) | 2.25 | 1.5 |
| PEPPERMINTOIL OPTAMINT 219843 (Symrise) | 2.25 | 1.5 |
| STEVIA RA 80 (Beneo) | 0.15 | 0.1 |
| Total | 150 | 100 |

300 kg (2 batches for the kneader) of this recipe were made in a 250 litre kneader from Gabler GmbH & Co. KG.

b) Kneading:

The kneader was heated to 50° C., the glycerol and the gum base were filled in and warmed up. The mixture was kneaded for 10 min. 80 kg of the non-hydrogenated isomaltulose and the intense sweetener were added in 3 steps (between 10 min kneading=30 min). The rest of the non-hydrogenated isomaltulose and the flavours were added. The mass was kneaded for 30 min.

c) Conditioning Step:

The obtained mixture was rested for 30 minutes.

d) Further Processing:

After a rest period of 30 min the mass was ready to start on a extruder before the rolling and scoring machine.

To start the extrusion process the mass was cutted into pieces (2-4 kg) and feed into the extruder. The temperature of the mass was 35-40° C. The discharge from the extruder was smooth on the edges so that the mass could be rolled and scored exactly. The cutted borders of the chewing gum sheets were refeeded automatically to the extruder, positioned at the beginning of the production line. The used talcum was also refeeded to the talcum hoard tank. The line has 5 rollers to bring the chewing gum mass to the right thickness and breadth. After the 5 prerollers, knife-rollers (lengthwise/across) were used. After cutting the sheets, the length and the thickness were measured and a metal detector was installed.

e) Result:

The stability of the chewing gum cores is very good and suited for each size of coating machines.

### EXAMPLE 3

### Chewing Gum Core Production Using Maltitol and Sorbitol According to the State of the Art

a) Recipe of a chewing gum core containing more maltitol:

| | [%] |
|---|---|
| GUM BASE DALIA (Cafosa) | 32 |
| MALTITOL | 44 |
| SORBITOL (Roquette) | 10 |
| LYCASIN 80/55 (Roquette) | 10.6 |
| MENTHOL 163592 (Symrise) | 1.4 |
| PEPPERMINTOIL OPTAMINT 219843 (Symrise) | 1.8 |
| ASPARTAME | 0.1 |
| ACESULFAME K | 0.1 |
| Total | 100 |

b) Recipe of a chewing gum core containing more sorbitol:

| | [%] |
|---|---|
| GUM BASE DALIA (Cafosa) | 32 |
| MALTITOL | 4 |
| SORBITOL (Roquette) | 50 |
| LYCASIN 80/55 (Roquette) | 10.6 |
| MENTHOL 163592 (Symrise) | 1.4 |
| PEPPERMINTOIL OPTAMINT 219843 (Symrise) | 1.8 |
| ASPARTAME | 0.1 |
| ACESULFAME K | 0.1 |
| Total | 100 |

c) Total Conditioning Time Needed

When preparing chewing gum cores according to the recipes

a) and b) following total conditioning times were needed to obtain coatable chewing gum cores:

For the chewing gum cores according to the recipes a) containing more maltitol a total conditioning time of 12 to 24 hours was needed.

For the chewing gum cores according to the recipes b) containing more sorbitol a total conditioning time of 24 to 48 hours was needed.

1. A process for intentionally shortening a conditioning time of a composition of a chewing gum core in a chewing gum preparation process, the process comprising:
a) providing hydrogenated or non-hydrogenated isomaltulose,
b) providing a chewing gum base composition,
c) mixing the hydrogenated or non-hydrogenated isomaltulose provided in step a) with the chewing gum base composition provided in step b) to obtain a hydrogenated or non-hydrogenated isomaltulose-containing composition of a chewing gum core,
d) subjecting the hydrogenated or non-hydrogenated isomaltulose-containing composition of a chewing gum core to a first shortened conditioning step and
e) forming the obtained hydrogenated or non-hydrogenated isomaltulose-containing composition of a chewing gum core into a chewing gum core,
wherein the conditioning time of step d) is reduced in comparison to the conditioning time of an amount equivalent maltitol-containing or sorbitol-containing composition of a chewing gum core.

2. The process according to claim 1, further comprising:
f) subjecting the chewing gum core to a second shortened conditioning step, and
g) coating the obtained chewing gum core,
wherein the total conditioning time of steps d) and f) is reduced in comparison to the conditioning time of an amount equivalent maltitol-containing or sorbitol-containing composition of a chewing gum core.

3. A process for intentionally shortening a conditioning time of a composition of a chewing gum core and/or of a chewing gum core in a chewing gum preparation process, the process comprising:
a) providing hydrogenated or non-hydrogenated isomaltulose,
b) providing a chewing gum base composition,
c) mixing the hydrogenated or non-hydrogenated isomaltulose provided in step a) with the chewing gum base composition provided in step b) to obtain a hydrogenated or non-hydrogenated isomaltulose-containing composition of a chewing gum core,
d) subjecting the hydrogenated or non-hydrogenated isomaltulose-containing composition of a chewing gum core to a first conditioning step,
e) forming the obtained hydrogenated or non-hydrogenated isomaltulose-containing composition of a chewing gum core into a chewing gum core,
f) subjecting the chewing gum core to a second conditioning step, and
g) coating the obtained chewing gum core,
wherein the total conditioning time of steps d) and f) is reduced in comparison to the conditioning time of an amount equivalent maltitol-containing or sorbitol-containing composition of a chewing gum core.

4. The process according to claim 1, wherein the hydrogenated or non-hydrogenated isomaltulose-containing composition of a chewing gum core is stored in the first shortened conditioning step d) for at most 5 hours.

5. The process according to claim 2, wherein the chewing gum core is stored in the second shortened conditioning step f) for at most 5 hours.

6. The process according to claim 5, wherein the total time of the conditioning steps d) and f) is at most 10 hours.

7. The process according to claim 1, wherein the chewing gum base composition comprises at least one water insoluble chewing gum base component.

8. The process according to claim 1, wherein the chewing gum base composition provided in step b) comprises at least one chewing gum base component selected from the group consisting of at least one sweetener component, at least one high intensity sweetener component, at least one flavouring component, at least one colouring component and at least one rolling component.

9. The process according to claim 1, wherein the chewing gum base composition provided in step b) comprises a sugar alcohol or a sugar.

10. The process according to claim 1, wherein hydrogenated isomaltulose is provided in step a).

11. The process according to claim 10, wherein the hydrogenated isomaltulose is provided in step a) in an amount of at least 10% to at most 60% by weight of the total weight of the obtained hydrogenated isomaltulose-containing composition of a chewing gum core.

12. The process according to claim 1, wherein non-hydrogenated isomaltulose is provided in step a).

13. The process according to claim 12, wherein the non-hydrogenated isomaltulose is provided in step a) in an amount of at least 10% to at most 75% by weight of the total weight of the obtained non-hydrogenated isomaltulose-containing composition of a chewing gum core.

14. Use of hydrogenated or non-hydrogenated isomaltulose in a composition of a chewing gum core for intentionally shortening the conditioning time of the composition of a chewing gum core in a chewing gum preparation process, wherein the conditioning time is shortened in comparison to the conditioning time of an amount equivalent maltitol-containing composition of a chewing gum core.

15. (canceled)
